(19) United States
(12) Patent Application Publication
(10) Pub. No.: US 2014/0248443 A1
(43) Pub. Date: Sep. 4, 2014

(54) SCREEN STENCIL AND METHOD FOR COATING SCREEN STENCILS

(71) Applicants: Florian Eder, Erlangen (DE); Heinrich Zeininger, Obermichelbach (DE)

(72) Inventors: Florian Eder, Erlangen (DE); Heinrich Zeininger, Obermichelbach (DE)

(73) Assignee: SIEMENS AKTIENGESELLSCHAFT, Muenchen (DE)

(21) Appl. No.: 14/348,487

(22) PCT Filed: Sep. 3, 2012
(86) PCT No.: PCT/EP2012/067104

§ 371 Date: Mar. 28, 2014

(30) Foreign Application Priority Data
Sep. 29, 2011 (DE) 10 2011 083 733.7

(51) Int. Cl. B41M 1/12; B41F 35/00

(52) U.S. Cl. CPC B41M 1/125; B41F 35/003
USPC 427/569; 118/723 R

(57) ABSTRACT

A stencil body of a screen stencil body has a surface coating made up of hydrocarbon-based, organic precursor molecules. A plasma-coating method is used to coat the screen stencil, wherein a layer of hydrocarbon-based, organic precursor molecules is deposited on the surface of the stencil body of the screen stencil.

### CROSS REFERENCE TO RELATED APPLICATIONS

This application is the U.S. national stage of International Application No. PCT/EP2012/067104, filed, Sep. 3, 2012 and claims the benefit thereof. The International Application claims the benefit of German Application No. 102011083733.7 filed on Sep. 29, 2011, both applications are incorporated by reference herein in their entirety.

### BACKGROUND

Described below are a screen printing stencil and methods of coating screen printing stencils, in particular with anti-stick coatings for soldering pastes.

Surface mounting of circuit boards involves a sequence of complex manufacturing operations wherein inter alia various substances are applied to the circuit board. Progressive miniaturization has resulted in the increased deployment of highly viscous and viscidly tacky substances such as, for example, soldering pastes because their pasty state provides the needed dimensional stability on the circuit board.

Surface mounting technology (SMT) frequently utilizes screen printing processes in which a screen printing stencil is used to apply a printing or soldering paste or an adhesive to certain points on a circuit board in accordance with a predetermined printed structure. The paste of solder/adhesive is squeegeed onto the particular circuit board through apertures in a metallic stencil body which correspond to the structure to be printed. The resultant regions of paste form pads whereto electronic components are applied and fixed using a pick and place machine for example.

Screen printing stencils can be essentially a dimensionally stiff frame which supports a fine woven fabric of metal wire, adhered to the frame under pre-tension. A thin-wall metallic stencil displaying the printed pattern formed by the apertures is secured in a central region of this metal wire fabric.

The screen printing stencils have to be downscaled in accordance with the miniaturization of the electronic components. This risks dots of solder or adhesive or paste depots adhering to the opening edges or walls of the metal used as stencil material which are determined by the particular printed pattern, so the corresponding apertures may gradually close up. This in turn frequently results in the outer edges of the pads applied to the circuit board tearing or breaking as the printing stencil lifts off. It may then possibly be no longer possible to meet the requirements to achieve a desired crisp printed image on the circuit board.

Printed publication DE 10 2005 045 350 A1 discloses a method of wet-chemically coating printing stencils with anti-stick coatings of metal alkoxide coating materials, for example in sol-gel processes.

Printed publication DE 102 31 698 A1 discloses a method of coating printing stencils with an anti-stick coating of siloxane- or hydrocarbon-based layers in a low-pressure plasma process.

Printed publication DE 10 2007 010 936 A1 discloses a screen printing stencil having a nanocrystalline anti-stick coating.

There is a need for chemically and mechanically stable, repeatedly reusable and easy-to-clean screen printing stencils and corresponding methods of fabricating such screen printing stencils.

### SUMMARY

One example accordingly is a screen printing stencil, having a stencil body, wherein the stencil body has a surface coating of hydrocarbon-based, organic precursor molecules.

One essential concept in creating an anti-stick coating for screen printing stencils is to not only offer good anti-stick properties with regard to pasty printing materials but is coatable via a simple-to-implement and economical process. There is further an additional advantage in that the surface coating is again residuelessly removable in a cleaning process which is very highly compatible with the coating process, thereby offering an appreciable improvement in the reusability of the screen printing stencil while printing properties remain at the same time at a qualitatively high level.

In one embodiment, the precursor molecules may include ethane, acetylene, methane, cycloaromatics, partially fluorinated hydrocarbons and/or mixtures thereof. The surface coating can thereby develop an anti-stick effect with regard to pasty printing materials, for example soldering pastes or adhesive pastes. At the same time, the surface coating can advantageously be redetached again from the screen printing stencil in a plasma cleaning process, making it simple to recoat the screen printing stencil.

In one embodiment, the stencil body may have a multiplicity of apertures adapted to lead a printing material in a predetermined printed structure through the screen printing stencil onto a circuit board to be printed. The surface coating is particularly useful for screen printing stencils of this type, since the surface coating can be applied to the stencil body in a plasma process, and so the screen printing stencil can also be uniformly coated at its edges and structuring patterns, and this in turn improves the consistency of the screen printing process.

In one embodiment, the surface coating can cover the inner walls of the apertures with a homogeneous thickness for the coating. This offers the advantage that a particularly crisp screen print becomes possible with the screen printing stencil.

The method of coating a screen printing stencil described below includes depositing a layer of hydrocarbon-based, organic precursor molecules on the surface of a stencil body of the screen printing stencil using a plasma coating apparatus, in particular an atmospheric pressure plasma coating apparatus. This method is notable for reduced wetting issues compared with wet-chemical processes. The method ensures layer properties which are good, for example a low vulnerability to mechanical stress, good resistance to hydrolysis and high resistance to solvents. Lastly, it is advantageously possible to eschew the use of solvents or surfactants and also a thermal cure for the precursor molecule layer.

In one embodiment, the depositing can be preceded by cleaning the stencil body of the screen printing stencil of printing material residues and/or organic contaminants using a plasma from the plasma coating apparatus. This offers the advantage that recoating and prior cleaning of the screen printing stencil can be carried out in a single plasma apparatus, leading to appreciable savings in time and cost.

In one embodiment, the cleaning can is carried out by using oxygen, compressed air or forming gas as process gas. This can be used not only to remove organic contaminants, but also blow off inorganic particles with the process gas stream and the neutralization of the surface partial charges which occurs in the plasma, in a simple and effective manner.

In one embodiment, a surface coating already present on the stencil body can be removed by the cleaning. This ensures that with every clean a fresh coating can be applied to the surface, thereby appreciably improving the reliability of the screen printing stencil in printing and hence the process consistency.

The stencil body may be maintained at a temperature of below 10° C. during the depositing. This not only increases the deposition rate but also improves the structural chemical properties of the deposited layer.

In one embodiment, the depositing can be carried out by using forming gas or some other hydrogen-argon mixture as ionization gas.

In one embodiment, the depositing can be carried out under atmospheric pressure. This is particularly advantageous, since plasma coating under atmospheric pressure is particularly efficient and inexpensive to carry out.

Described below is a printing stencil cleaning apparatus adapted for carrying out a method of coating a screen printing stencil.

### BRIEF DESCRIPTION OF THE DRAWINGS

These and other aspects and advantages will become more apparent and more readily appreciated from the following description of the exemplary embodiments, taken in conjunction with the accompanying drawings, where:

FIG. 1 is a schematic depiction of a screen printing stencil,

FIG. 2 is a schematic depiction of a detail of a screen printing stencil, and

FIG. 3 is a block diagram schematically depicting a method of coating a screen printing stencil.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The refinements and developments described can be combined with each other in any desired manner, if sensible. Further possible refinements, developments and implementations of also comprehend combinations not recited explicitly of features described hereinbefore or hereinafter in the context of the exemplary embodiments.

The accompanying drawings are intended to convey further understanding of the embodiments. They illustrate embodiments and are designed to explain principles and concepts in cooperation with the description. Other embodiments and many of the advantages referred to will be apparent from the drawings. The elements of the drawings are not necessarily shown true to scale relative to each other. Like reference signs denote components of like or similar action.

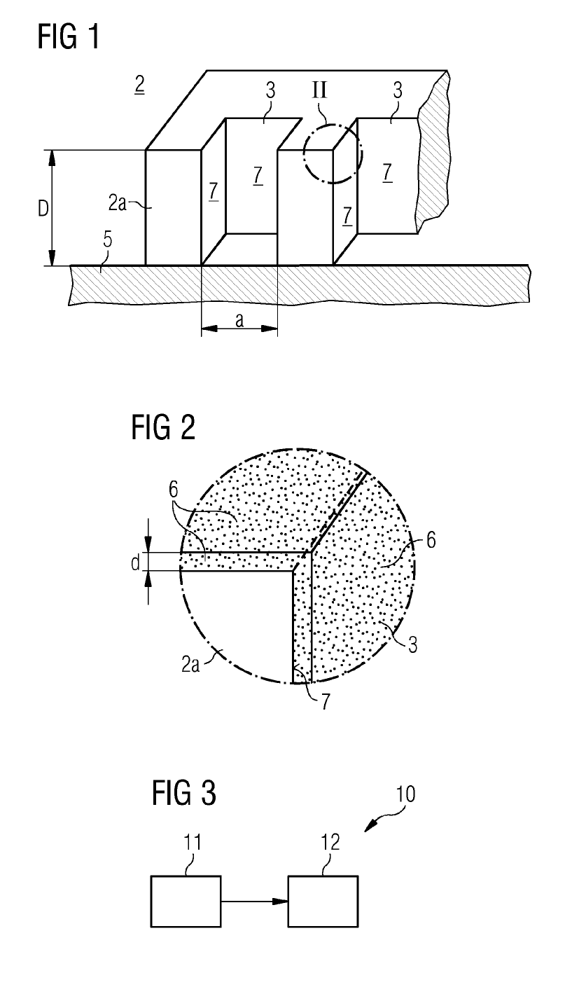

FIG. 1 shows a schematic depiction of a screen printing stencil 2. The screen printing stencil 2 has a stencil body 2a which can be, for example, a steel such as in particular a special grade steel, for example a CrNi steel, or of Ni or some other Ni alloy.

The thickness D of stencil body 2a can be between 100 and 5000 μm for example.

Stencil body 2a may have apertures 3 produced by laser technology or electrotype processes for example. The maximum dimension a of these apertures 3 can be for example between 200 μm and 500 μm, for example be about 300 μm. The maximum dimension a depends on the size desired for the pad or contact area to be applied of a printing material such as in particular a soldering or adhesive paste on a circuit board 5 underneath. The shape of the apertures 3 can be dependent on a printed pattern to be applied to the circuit board 5. The printed pattern can be adapted to lead a printing material in a predetermined structure through the screen printing stencil 2 onto the circuit board 5 to be printed.

The screen printing stencil 2 is pressed onto the circuit board 5 for the printing process. A soldering or adhesive paste is then introduced from the open side of the apertures 3 by a squeegee brushing across the free surface of the screen printing stencil 2. In order that the soldering or adhesive paste may detach cleanly from the screen printing stencil 2, in particular from the inner walls 7 of its apertures 3, as the screen printing stencil 2 lifts off the circuit board 5 following this printing process, the stencil body 2a has a uniform or at least regional surface coating 6, as shown schematically in FIG. 2 for a detail identified as II in FIG. 1.

The surface coating 6 has an anti-stick effect with regard to a soldering or adhesive paste; that is, the tear-off behavior at the inner walls 7 of the apertures 3 in the screen printing stencil 2 is reduced/suppressed by the surface coating 6. This surface coating 6 may be constructed of hydrocarbon-based, organic precursor molecules.

Precursor molecules of this type may include for example ethane, acetylene, methane, cycloaromatics, ethylbenzene, partially fluorinated hydrocarbons and/or mixtures thereof. A possible mixture for surface coating 6 may include, for example, a mixture of acetylene and methane.

Layer thickness d of surface coating 6 may be between 50 nm and 1000 nm for example. It is advantageous in this connection for layer thickness d to be applied particularly in the region of the inner walls 7 of the apertures 3 and also their edges and corners on the stencil body 2a in a homogeneous manner; that is, for a conformal surface coating 6 to be applied to stencil body 2a. This enhances the contour crispness of the printing process with the screen printing stencil 2.

FIG. 3 schematically depicts a method 10 of coating a screen printing stencil, in particular a screen printing stencil 2 as per FIGS. 1 and 2. The method 10 can be for example a plasma coating process which can be carried out in a plasma coating apparatus under atmospheric pressure. For example, method 10 can be carried out in an atmospheric pressure plasma apparatus (Plasmatreat AS400) at a plasma frequency of below 22 kHz, with a plasma cycle time of below 30% and the use of compressed air, forming gas or of a hydrogen-argon mixture as process gas.

It is optional that the stencil body of the screen printing stencil can initially be cleaned 11 of printing material residues and/or organic contaminants such as flux residues using a plasma produced by the plasma coating apparatus. All organic and inorganic contaminants can be removed with the cleaning 11 for example. This can be done using for example oxygen, compressed air, forming gas or a hydrogen-argon mixture, so the corresponding particles of solid material are simply blown away in the fast stream of air. The cleaning of a screen printing stencil coated with a surface coating can be carried out in an appreciably simpler and faster manner than the cleaning of an uncoated screen printing stencil.

Depending on the setting of the plasma flame, the surface coating can also be removed at the same time during the cleaning 11, so a screen printing stencil freed of all molecules will again be present.

The final operation is depositing 12 a layer of hydrocarbon-based, organic precursor molecules on the surface of the optionally cleaned stencil body of the screen printing stencil using the same plasma coating apparatus as optionally used for cleaning the screen printing stencil. This offers enhanced efficiency in the process chain, since the screen printing stencils do not have to be transposed into some other apparatus.

The plasma jet, which may be equipped with a built-in potential grating for example, can for this purpose be switched over to coating operation; that is, precursor molecules admixed into the plasma are deposited as a polymeric anti-stick coating on the surface of the stencil body. This deposition accordingly offers the advantage of uniform deposition on inner walls, edges and corners of the apertures in the screen printing stencil as well as elsewhere. The depositing 12 can also be effected for example when a screen printing stencil has just been modified on account of layout changes of the printed pattern and therefore has to be recoated. The surface coating on the screen printing stencil may have a contact angle of about 105° and a hysteresis of 8° when ethylbenzene is used as precursor molecules for example.

The depositing 12 can be carried out for example with forming gas or some other hydrogen-argon mixture as ionization gas. Varigon® (Linde) can be used for this purpose for example. It is further possible for the screen printing stencil to be cooled to a temperature below 50° C., especially below 10° C., during the depositing. The process parameters chosen may have process values which ensure minimal input of energy into the plasma flame in order that the precursor molecules may not be combusted.

The resulting screen printing stencil has a stencil body with a surface coating of hydrocarbon-based, organic precursor molecules. The plasma coating method produces a screen printing stencil with a layer of hydrocarbon-based, organic precursor molecules deposited on the surface of the stencil body of the screen printing stencil.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-8. (canceled)

9. A method of coating a screen printing stencil, comprising:
depositing a layer of hydrocarbon-based, organic precursor molecules on a surface of a stencil body of the screen printing stencil using a plasma coating apparatus while the stencil body is maintained at a temperature below 10° C.

10. The method as claimed in claim 9, wherein the plasma coating apparatus is an atmospheric pressure plasma coating apparatus.

11. The method as claimed in claim 10, further comprising, prior to said depositing, cleaning the stencil body of the screen printing stencil of printing material residues and/or organic impurities using a plasma from the plasma coating apparatus.

12. The method as claimed in claim 11, wherein said cleaning uses at least one of compressed air and forming gas as a process gas.

13. The method as claimed in claim 12, wherein said cleaning removes a surface coating of hydrocarbon-based, organic precursor molecules on the stencil body.

14. The method as claimed in claim 13, wherein the organic precursor molecules include at least one of ethane, acetylene, methane, cycloaromatics and partially fluorinated hydrocarbons.

15. The method as claimed in claim 14, wherein said depositing uses at least one of forming gas and another hydrogen-argon mixture as ionization gas.

16. The method as claimed in claim 15, wherein said depositing occurs under atmospheric pressure.

17. The method as claimed in claim 11, wherein said cleaning removes a surface coating of hydrocarbon-based, organic precursor molecules on the stencil body.

18. The method as claimed in claim 9, wherein the organic precursor molecules include at least one of ethane, acetylene, methane, cycloaromatics and partially fluorinated hydrocarbons.

19. The method as claimed in claim 9, wherein said depositing uses at least one of forming gas and another hydrogen-argon mixture as ionization gas.

20. The method as claimed in claim 9, wherein said depositing occurs under atmospheric pressure.

21. A printing stencil cleaning apparatus, comprising:
a plasma coating apparatus depositing a layer of hydrocarbon-based, organic precursor molecules on a surface of a stencil body of the screen printing stencil while the stencil body is maintained at a temperature below 10° C.

22. The printing stencil cleaning apparatus as claimed in claim 21, wherein said plasma coating apparatus is an atmospheric pressure plasma coating apparatus.

23. The printing stencil cleaning apparatus as claimed in claim 22, wherein said plasma coating apparatus produces a plasma cleaning the stencil body of the screen printing stencil of printing material residues and/or organic impurities.

24. The printing stencil cleaning apparatus as claimed in claim 23, wherein said plasma coating apparatus uses at least one of compressed air and forming gas as a process gas during cleaning of the stencil body.

25. The printing stencil cleaning apparatus as claimed in claim 24, wherein said plasma coating apparatus removes a surface coating of hydrocarbon-based, organic precursor molecules on the stencil body.

26. The printing stencil cleaning apparatus as claimed in claim 25, wherein the organic precursor molecules include at least one of ethane, acetylene, methane, cycloaromatics and partially fluorinated hydrocarbons.

27. The printing stencil cleaning apparatus as claimed in claim 26, wherein said plasma coating apparatus uses at least one of forming gas and another hydrogen-argon mixture as ionization gas during the depositing of the layer of the organic precursor molecules.

28. The printing stencil cleaning apparatus as claimed in claim 27, wherein said plasma coating apparatus operates at atmospheric pressure.
